(19) United States
(12) Patent Application Publication
(10) Pub. No.: US 2019/0240668 A1
(43) Pub. Date: Aug. 8, 2019

(54) INFORMATION MARKING SYSTEMS AND METHODS FOR LABWARE

(71) Applicant: MICRONIC HOLDING B.V., Lelystad (NL)

(72) Inventors: Gijsbert van der Gaag, Lelystad (NL); Cornelis Johannes Verton, Lelystad (NL); Patrick Erwin van Wijk, Emmen (NL); Hanjeko Merkus, Almere (NL); Bartholomeus Wilhelmus Kramer, Lelystad (NL)

(21) Appl. No.: 16/259,450

(22) Filed: Jan. 28, 2019

Related U.S. Application Data
(60) Provisional application No. 62/625,466, filed on Feb. 2, 2018.

(51) Int. Cl. B01L 3/00; B65C 9/26; G06F 3/0484; G06F 3/0482

(52) U.S. Cl. CPC B01L 3/5453; B65C 9/26; B01L 2300/021; G06F 3/0482; G06F 3/04845

(57) ABSTRACT

An automated labware marking system that includes a platform. The platform includes at least one slot for receiving a labware. The labware includes a rack and a plurality of labware containers. The rack further includes a plurality of cavities for receiving the plurality of labware containers. The automated labware marking system includes a marking device for marking the labware. A first sensor detects a marking area on the labware for marking. A second sensor is configured to take information of each labware container before the labware container is marked by the marking device. A manipulator moves at least one labware container from the rack to a labware holding device and places the at least one labware container in a position suitable for marking by the marking device.

### PRIORITY CLAIMS

This application claims the benefit of U.S. Provisional Application No. 62/625,466, filed Feb. 2, 2018, entitled “Information Marking Systems and Methods for Labware”. The contents of the aforementioned application are incorporated herein in their entirety for all purposes.

### FIELD OF INVENTION

This disclosure is related to an automated information marking system. More specifically, this disclosure is related to an information marking system comprising a marking device and labwares that are optimized in order to make them more suitable for marking with information on a marking surface.

### BACKGROUND OF THE INVENTION

High-capacity, mass-processing of samples is increasingly important for modern industries and academics to expedite their sample handling and storage processes for research, diagnostic, and other activities.

During the processes of handling and storage, samples need to be stored in containers of some kind. Such containers can be called labwares.

Labwares are widely used in many different laboratory settings. Laboratories play an important role in the activities of universities, pharmaceutical companies, medical companies (such as e.g. diagnostic laboratories), biobanks, forensic institutes, agricultural biotech companies (such as e.g. seed companies), chemical companies, and the like.

Such companies may have activities in the fields of DNA quantification, PCR, lab-on-a-chip, bioanalysis, antibody supply, cohort sample collection, field sample collection, and the like.

Labwares that are suitable for marking with information comprise tubes, cassettes, caps, carriers, and the like, for holding samples. Carriers may be racks, lab-on-a-chip carriers, (q)PCR-plates, and the like.

In order to reliably and prolongedly identify each sample, during handling and storage, samples need to be traceable in a secure and reliable way.

Labwares that contain samples need to be marked with information regarding the samples, so that the samples contained in the labwares are traceable.

Currently, researchers manually mark such information on the labwares using markings that are not permanently attached to the labwares. In some situations, marking is done by writing directly on the labwares using felt-tip pens, by using a directly printing tube-by-tube marking device, or the like. In other situations, the information is hand-written or printed on a piece of sticky label that is attached to the labwares. In still other situations, manual marking is physically impossible because of the small sizes of the labwares. In still other situations, manual marking is physically impossible for other reasons, such as the materials that the labwares are made of

In cases where information is applied to the labwares in hand-written form, there is a risk that the information is incorrect. There is also a risk that the hand-written information is not clearly readable. Thus, the traditional hand-marking method is prone to human error.

In cases where the information is on a piece of sticky label, the information bearer can easily get detached from the labwares. Thus, the traditional marking method bears the risk that markings get lost during the processes of sample handling and storage. The ensuing loss of traceability of the samples may jeopardize the corresponding research and development.

The increasing high-capacity, mass-processing of labwares vastly increases the risks of the traditional (hand-) marking methods.

The invention provides a system to mark information on labwares in a secure and lasting manner and thus, to minimize the risk that samples and/or the information they represent, get lost. The marking system can be used in laboratories and manufacturing facilities of all kinds.

### SUMMARY OF THE INVENTION

This disclosure generally relates to an information marking system for marking labwares in an automated way using a manipulator. More specifically, this disclosure relates to an information marking system comprising a marker in combination with labwares. Labwares can be optimized so that they are specially suitable for marking with information on a marking surface. U.S. Pat. No. 6,270,728 to Wijnschenk et al., describing various features of labwares, is hereby incorporated in its entirety as Exhibit A, which is part of this disclosure.

The embodiments of the information marking system disclosed herein are designed to remove the manual process of marking labwares, which is prone to human error and which bears the risk of loss of traceability of the samples. The marking system marks the information on the labwares in a fully automated way, minimizing the risk of human error. The marking system marks the information on the labwares in such a manner that the markings are indelibly and permanently attached to the labwares, minimizing the risk of loss of traceability of the samples.

The marking system enables the user to mark labware products with information regarding the labware and/or the sample stored within. The markings that are applied by the marking system may contain much more information and much more varied information about each sample than the amount and the type of information that is physically possible to apply to the labware products using the traditional marking methods.

The information marking system and its various embodiments herein provided can mark information on the labwares in various ways. In one embodiment, the labwares are fed to the marker in an automated operation, with the labwares brought into position to the marker by a manipulator. In another embodiment, the labwares are also fed to the marker by a manipulator but the labwares are drawn from a labware hotel, which significantly increases the capacity over the first embodiment.

### BRIEF DESCRIPTION OF THE DRAWINGS

FIG. 1 shows a marking system according to an embodiment of the disclosure.

FIG. 2 shows a marking system according to an embodiment of the disclosure.

FIG. 3 shows a labware holding device according to one embodiment of the disclosure.

FIG. 4 shows a labware holding device according to one embodiment of the disclosure.

FIG. 5 shows a marking system according to an embodiment of the disclosure.

FIG. 6 shows an example of a labware hotel drawer system that has 6×4 slots for receiving racks according to one embodiment of the disclosure.

FIG. 7 shows a method 1100 for marking labwares according to one embodiment of the disclosure.

FIG. 8 shows a graphical user interface (GUI) of a main screen from which most operations will be performed according to one embodiment of the disclosure.

FIG. 9 shows a GUI of a rack edit according to one embodiment of the disclosure.

FIG. 10 shows a GUI allowing a user to view and edit the global labwares list according to one embodiment of the disclosure.

FIG. 11 shows a GUI allowing a user to manage the laser template files according to one embodiment of the disclosure.

FIG. 12 shows various embodiments of labware containers with markings according to an embodiment of the disclosure.

FIG. 13 shows various embodiments of labware containers with markings according to an embodiment of the disclosure.

FIG. 14 shows a plurality of labware containers organized on a rack according to an embodiment of the disclosure.

FIG. 15 shows an example of 96-format of labware containers according to one embodiment of the disclosure.

### DETAILED DESCRIPTION OF THE INVENTION

### A. Definitions

The term “labware” or “labwares” comprises containers for holding substance, e.g., a sample, for the purposes of identification, processing, analysis, storage, or the like. Labware containers can be tubes, cassettes, dishes, or the like. Labware containers can be organized, e.g., in a matrix of 384 (16×24), 196 (14×14), 144 (12×12), 100 (10×10), 96 (8×12), 81 (9×9), 48 (6×8), 24 (4×6), 12 (3×4), 6 (2×3), or another number of units. Labware can also comprise caps (screw caps, push caps, plug style caps, and the like) to close off the labware containers. Labware containers can be organized in receptacles such as e.g., racks, or in other receptacles. Receptacles may be based on the ANSI/SLAS format, or on different formats. Labware can also comprise glass slides or plates, e.g., microscopic sample slides, petri dishes, or the like. Labwares may be made from plastic (e.g., PP, PE, PS, PET, PC, or the like), metal (e.g., steel, aluminium, or the like), glass, or other materials suitable for the purposes.

The terms “sample” and “substance” may be used interchangeably to mean a material of interest stored in a labware. Such sample or substance may be a liquid, powder, tissue, seeds, or any other material used by the person in the laboratory.

The term “information” means any individualized or grouped, traceable information with regard to the labware and/or the substance held by the labware container. Information can have the form of text, letters, numbers, symbols, images, codings (1D, 2D, QR, etc.), or the like. Information can also be the volume of the substance in the container, the manufacturing date of the substance in the container, the date of handling of the labware, personalized information relating to the substance in the container, or the like. Information can also be any other information required by the user of the information marking system. Information can be in the form of one code only or in the form of a combination of codes.

The term “coding” or “codings” means the information that is marked by the marking system on the labware. The term can also refer to the pre-applied information on the labware that can be read by a reader, a scanner, or the like, and that can be used as input for the marking by the marking system.

The term “marking” means the process of marking the information on the labware. Marking can be done by laser etching, engraving, printing (e.g., using ink, thermal printing, ink-jet printing, or other printing methods), labelling, incorporating a chip, or the like.

The term “chip” refers to a mechanical information carrier, such as e.g., a Radio Frequency Identification (RFID) chip, a Micro Electro Mechanical System (MEMS) chip, a micro transponder, or another carrier that uses wireless signal and that can be read by a sensor.

The terms “label area” and “marking area” may be used interchangeably to refer to an area on the labware that is used for marking with codings. This area can be optimized for marking to improve the quality of the marking.

The term “label area or marking area detection system” means the system that detects the marking area on the labware that is optimized for marking. Detection may be done via detecting presence/absence of label area, or using a different method. The precise detection of the marking area on the labware is important for the precise orientation of the labware so that the labware is positioned optimally for the marker. The detection system can be a vision system, e.g., a camera including software, a sensor, a light detection system, or the like.

The terms “detect” and “detection” refer to the working of the label area or marking area detection system.

The term “platform” refers to a location of the information marking device that can have one or more holders or slots for receiving one or more labwares, such as labware containers or racks.

The term “manipulator” comprises the following aspects. In one form, the manipulator can be an XYZ robotic system including a pick head, a gripper, or the like, that can hold the labwares and that can move and turn the labwares. In another form, the manipulator can be a robotic arm, or another mechanical means, to transport the labwares from one point to another point, and/or to position and hold labwares in place for marking. In yet another form, the manipulator may refer to a human and/or a user who uses the marking system.

The term “rotary holder” comprises the following aspects. A rotary holder is a mechanical part, a turn table, a labware holder, or the like, that can hold the labware in place while the labware is put in the exact right position for marking by turning the rotary holder or the manipulator.

The term “labware hotel” means a drawer system, a racking system, a rack loading system, or the like, that increases the number of labware into the Z-direction without significantly increasing the footprint of the system.

The term “controller” refers to a computer, a processor, a mini-computer, or the like, that can either be an integral part of the system or that can be connected to the system from outside. The controller uses software to operate the marking system.

### B. General Description of the Marking Process

The information marking system is a system for the automated placing and marking of labwares. The system comprises a marking device and specially designed labwares.

Marking Device

The marking device is housed in a marking machine. The machine includes an exterior case, such a e.g., a chassis. The exterior case can be built from metal (e.g., aluminium) panels on all sides. The machine includes a door. The machine includes different control buttons, e.g., an external start button, an external reset button, an external emergency stop, or other control buttons. The door of the information marker can have a small viewing window. The viewing window can be made from special laser-safe glass.

The marking device has moving parts which are not normally exposed. As a security measure, the door interlock ensures no parts are moving when the door is open.

The marking machine can be a benchtop machine.

The marker machine is CE/UL approved. The marker machine can have a 110/240V single phase power supply. User manuals in various languages may be included.

In one embodiment, the information marker includes a laser marker for optimized marking of labwares by laser etching. In other embodiments, other means can be used for other methods of marking such as e.g., engraving, printing (e.g., using ink, thermal printing, ink-jet printing, or other printing methods), labelling, incorporating a chip, or the like.

In the embodiment that comprises a laser, the interior of the machine houses a laser with a lens that is optimized for laser marking labwares. The laser system can include a high-power laser head that emits laser light that has sufficient energy to mark the labware. The laser can be F20CW1-F20Compact, or the like. The laser lens can be any suitable lens.

In one embodiment, the information marking system comprises a laser for marking the information. The laser system emits one laser beam. Thus, one labware is marked at a time. This laser system would work with a single slot or a single labware holder.

In another embodiment that comprises a laser, the laser system emits a plurality of laser beams. Thus, a plurality of labwares can be marked simultaneously. This laser system would work with a multi-labwares slot or holder.

In other embodiments, the information marking system may use a thermal printing method to mark the labwares. The thermal printing method includes a strip of thermal plastic. The thermal plastic can be permanently attached to a labware with an appropriate amount of heat applied on an attaching surface of the thermal plastic. The thermal plastic can be a strip of plastic that includes one or more layers.

In one embodiment, the thermal plastic includes a single layer. The thermal plastic has one surface configured to attach to a labware. The thermal plastic has another surface configured to be marked. The marking on the surface of the thermal plastic can be done by pixel heating, laser marking, ink printing, engraving, or incorporating a chip.

In another embodiment, the thermal plastic includes two layers. The first layer has a first surface for attaching to a labware. The first layer has a second surface attached to a first surface of a second layer. The second layer may be made with materials or be in a color, e.g., white or silver, that enhances the contrast (improving the readability) of the marked information. The marking of the second layer may be done by pixel heating, laser marking, ink printing, engraving, or incorporating a chip. The second layer may appear to be in white, opaque, metallic, or silver looking.

In yet another embodiment, the thermal plastic includes three layers. The first layer has a first surface for attaching to a labware. The first layer has a second surface attached to a first surface of a second layer. The second layer may be made with materials or be in a color, e.g., white or silver, that enhances the contrast (improving the readability) of the marked information. The marking of the second layer may be done by pixel heating, laser marking, ink printing, engraving, or incorporating a chip. The second layer may appear to be in white, opaque, metallic, or silver looking. The third layer may be a clear plastic that covers the second layer to protect and prolong the marking effect made on the second layer. It is possible that the third layer allows laser to penetrate, such that the second layer can be marked by appropriate lasers through the third layer.

The information marking system can include one or more viewing windows. Users can see the information marking process from the viewing windows. High-power laser light can be a health hazard, as any direct viewing of the marking can cause permanent eye damage. For this reason, as a security measure, the viewing window can be made from special laser-safe glass.

As another security measure, an interlock on the front door ensures the laser is never active when the door is open. Control measures can be: 1. The laser may never be active without the front door interlock and side panel interlock active. 2. The laser cannot directly point at the front door or be visible from the outside, reducing risk only to reflected light.

The laser marker may produce low levels of toxic fumes during the marking process. These fumes are directed through a filter. Control measures can be: 1. Activated carbon filter on exhaust. 2. The marking chamber of the information marking system is maintained at negative pressure to prevent escape of fumes.

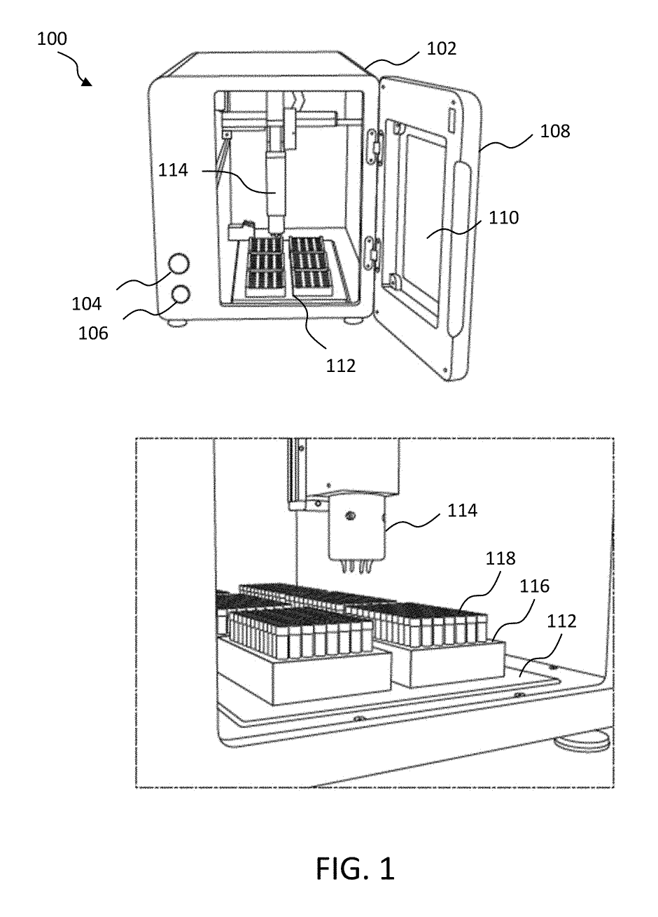

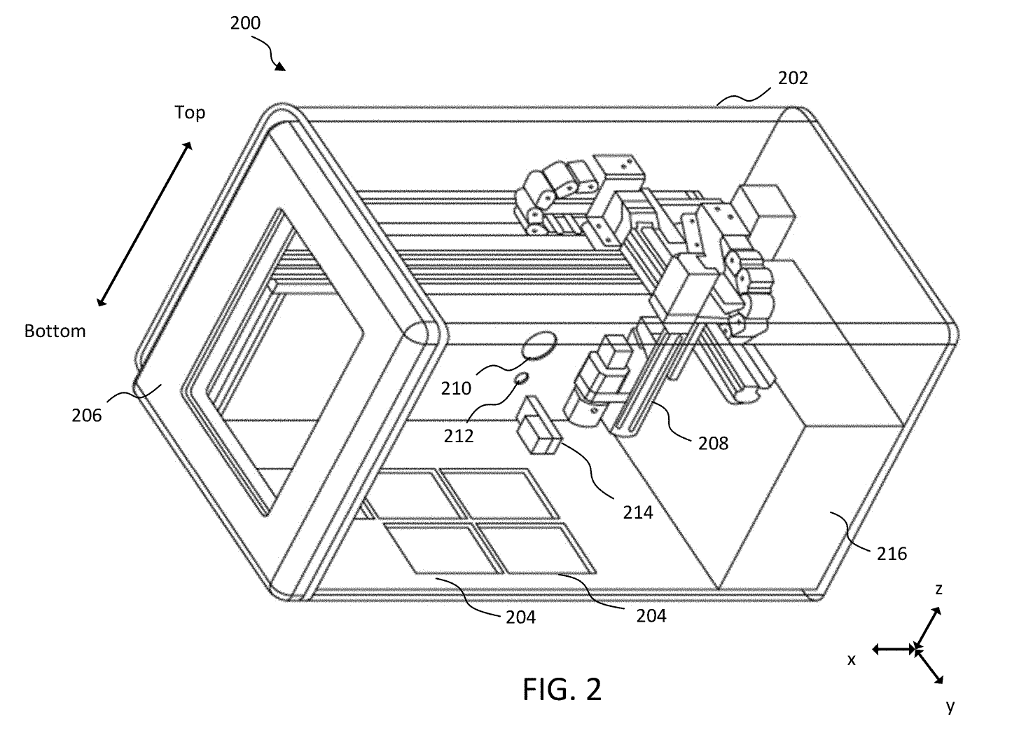

FIG. 1 and FIG. 2 show different embodiments of information marking systems according to embodiments of the disclosure. The embodiment may include the following characteristics. The marking process is fully automated and has 6-rack capacity. The marking process operates at high speed, e.g., 15 secs/labware container. The marking process has a high walkaway capacity, e.g., of over 2.5 hours. The marking system has a marking area detection system for exact positioning of the labwares. The marking system has an optical reading system, such as e.g., a 2D code and 1D barcode scanner built-in to read pre-applied information on the labware containers. The marking system has a label verification system. The laser marks directly on the surface of labware containers from 0.75 ml to 15 ml. The marking system has spreadsheet file input\output capability.

The marking system 100 includes a chassis 102 and a front door 108. The front door 108 is hinged on the chassis 102 and is openable. The front door 108 has a viewing window 110. The marking system 100 includes a start button 104 and a stop button 106. The start button 104 allows the operator to start the marking process. The stop button 106 allows the operator to stop the marking process.

The marking system 100 includes an internal cavity. The internal cavity has a bottom surface 112 that serves as a platform and that is sufficient to house six racks 116. Each rack may include a matrix of a plurality of labware containers 118.

The marking system 100 includes an XYZ robotic system 114 which is capable of moving in all three dimensions, X-axis, Y-axis, and Z-axes. The XYZ robotic system 114 may automatically pick up each individual labware container 118 for marking the desired information. In one embodiment, the XYZ robotic system 114 may include a laser light source to burn, engrave, or print the desired information on the labware container 118. In another embodiment, there is one or more laser light source independent from the XYZ robotic system 114 disposed inside of the internal cavity of the marking system 400. The XYZ robotic system 114 may pick up a labware container and put it in front of the laser light source for marking.

The marking system 100 can execute the marking process in a fully automated manner. The marking system 100 may include a controller that has a processor to execute various instructions. The marking system 100 may import a first spreadsheet, e.g., an Excel file. The first spreadsheet may include the identity (e.g., the 2D code pre-applied at the bottom surface of the labware container) and location of each individual labware container. The first spreadsheet may also include the desired marking information for each individual labware container. The desired marking information represents the sample that is stored or will be stored in the labware container.

After the marking process is done, the marking system 100 may generate a second spreadsheet that shows the correlation among the labware container identity, labware container location, and marked information. The second spreadsheet allows the operator to easily confirm whether the marking process was successfully conducted.

The marking system 100, 200, and 500 may include a marking area detection system. The marking area detection system detects the position of the label area or marking area of the labware. In one embodiment, marking area is detected by the relative positions between the marking area and a twist-lock mechanism. For example, the gripper of the XYZ robotic system transports the labware to the rotary holder 314 and places the labware on the rotary holder 314. The gripper exerts a slight pressure to hold the labware, while the rotary holder rotates a predefined number of times. When the twist-lock locks the labware in place, the labware is secured in the rotary holder. Once the twist-lock is in position, the relative position of the marking area is known.

In another embodiment, the marking area detection system may use a light source and an optical sensor. With the light source and the optical sensor, the detection system senses the difference in reflections to detect the marking area. For example, the light source may emit a light beam onto the labware. The optical sensor may detect the reflection of the light beam. In one embodiment, the marking area may have a lower reflection rate. Thus, the labware may be rotated in front of the light beam, when the reflection of the light beam is reduced, the edge of the marking area is detected. In yet another embodiment, the optical sensor can be a camera that takes a picture of the labware that is decoded by the software of the detection system.

In another embodiment, the marking area detection system may include both twist-lock mechanism and the optical sensor mechanism. The position of the edge of the marking area identified by the optical mechanism is compared to the expected position of the marking area identified by the twist lock mechanism.

The locations of the twist locks in the rotary holder have a set reference for the encoder of the motor of the rotary holder. When the position of the marking area is identified, the motor of the rotary holder starts and the rotary holder positions the marking area in the exact right position for the marking device.

FIG. 2 shows another implementation of a marking system different from FIG. 1.

The marking system 200 includes a chassis 202 and an access door 206 allowing the labwares to be transported in and out of the chassis 202. The marking system 200 includes a plurality of rack placing slots 204. In one embodiment, the marking system 200 includes 1-12 rack placing slots. Each rack can hold multiple pieces of labware containers.

The marking system 200 further includes an XYZ robotic system 208. The XYZ robotic system 208 has at least three-dimensional freedom, i.e., X-, Y-, and Z-axes. In one embodiment, the XYZ robotic system 208 may also have an X-Y plane rotational freedom. The XYZ robotic system 208 can pick up any labware container and move it in front of the laser marking aperture 212 for marking. In one embodiment, marking each labware container takes 1-20 secs to finish.

The marking system 200 includes a scanner with a scanning lens 210. The scanning lens 210 observes the laser marking process and provides feedback control to the laser marking process. The scanner deflection unit with X-Y galvanometer mirror mounts and mirrors for 1064 nm. The scanner includes a scanning lens with objective focus length of 160 mm, protection glass anti-reflective, and an observation field 110×110 mm.

The marking system 200 may further include a labware holder 214. The labware holder may have four-dimensional moving freedoms, i.e., X-, Y-, Z-axes, and a rotational axis. In one embodiment, the XYZ robotic system 208 picks up a labware container from a rack and puts it on the labware holder 214 for marking. After the labware container is marked, the XYZ robotic system 208 will pick up the marked labware container and put it back to its original position.

In one embodiment of the invention, the laser head is in a fixed position in the machine. In this embodiment, the labware is making movements and the laser head is standing still. The labware is handled through a repeating set of steps. The movements can be actuated by stepping motors or other means. In this embodiment, the marking system can be a chassis having three levels of drawers vertically staked (three floors). The marking system includes a table unit made of aluminium profiles having three floors; a controller; a working/coding area with small viewing window; a laser head without Z-axis.

The repeating set of steps can be performed by a manipulator and can comprise the following steps. Pick labware from its original position. Transport labware to the information marker field. Place labware in position in information marker field. Orientate labware in information marker field so that position of labware is optimal for marking. Mark labware with information. Transport labware back to original position or to another position. The repeating set of steps is performed in an automated way.

In this embodiment of the invention, the labwares are fed to the marker in an automated operation, with the labwares brought into position to the marker in an automated manner. This embodiment can handle multiple labwares individually in one cycle. In this embodiment, the marking system can operate with a manipulator to move the labwares inside the marking system. In this embodiment, marking can be done on the horizontal axis or on the vertical or height axis.

The labware is positioned by a manipulator using a pick head. Additionally the positioning of the labware can be optimized by a rotary holder that can position the marking area in the exact right position for the marker. The distance between the labware held by the manipulator and the marker (the focus) is adjustable.

When the information marking system is provided with a rotary holder, a manipulator picks up the labware that needs to be marked and moves the labware to the rotary holder. The gripper head that is part of the manipulator stays in position to support the labware at the top; the labware is supported by the rotary holder at the bottom. The marking system needs to line up the labware in the optimal position for marking by the marking device. This can be done e.g., by rotating the labware at the marking position and by checking the labware with a light sensor or a camera to detect the marking area. Once the orientation of the labware is set, the PLC or control board communicates the information to the marker and starts the marking process. The information marker operates at high speed, e.g., 15 secs/labware container. When the marking is ready, the labware can be placed back in its original position or can be placed in another defined position.

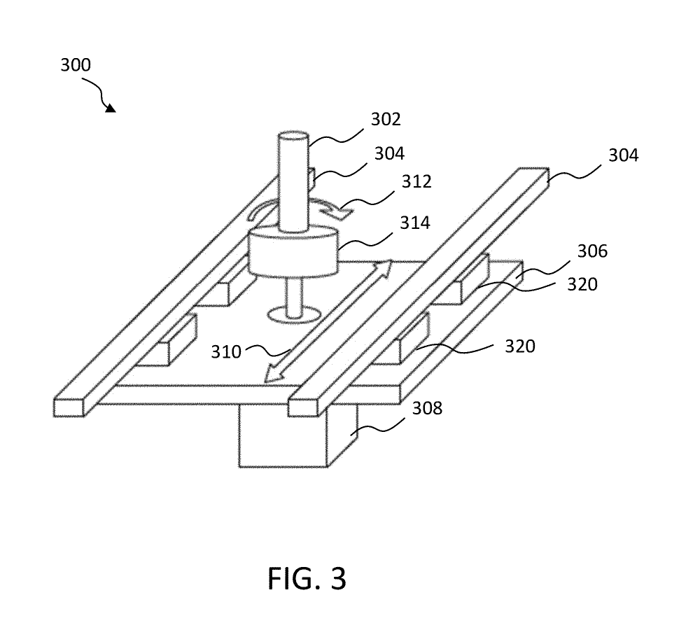

FIG. 3 shows a labware holding device 300 according to one embodiment of the disclosure. In some embodiments, the marking position has a rotary holder 314 for positioning the labware's marking surface proximate the laser.

The distance between the marking position and the laser (focus) is automatically or manually adjustable by moving the rotary holder 300. The gripper stays in position to support the labware container 302. At the marking position, a light sensor or camera checks the labware container. This checking assists the line-up of the labware for optimal marking. Once the orientation of the labware container is in place, the marking system controller communicates the information to the marker and starts the marking process. When the marking is done, the labware container is gripped again and placed back in its original position.

The labware container 302 is placed for a marker system that will apply the information. The marker system needs to place the labware container in a correct position, e.g., by rotating the labware container and sensing the labeling area. The labware container is brought into position, e.g., placed on a small turn table by an XYZ robotic system and the orientation is detected by a sensor or via optical detection by a scanning unit.

The labware holding device 300 includes two parallel guides 304 disposed on two sides of the rotary labware holder 314. Beneath each guide 304, there are two guide wagons 320 to support the guide. The guide wagons 320 connect the guide to the motor plate 306.

The motor plate 306 is attached to a motor 308. The motor 308 moves the motor plate in a first liner direction 310. In another embodiment, the motor 308 can rotate the labware holder 314 in a clockwise or counter clockwise direction 312. In another embodiment, there are multiple motors such that the holding device 300 can be moved in X, Y, and/or Z directions as well as rotational direction.

A labware container 302 is transported by an XYZ robotic system. The XYZ robotic system may grip the labware container from a rack and place it on top of a rotary labware holder 314 before the laser marking process begins.

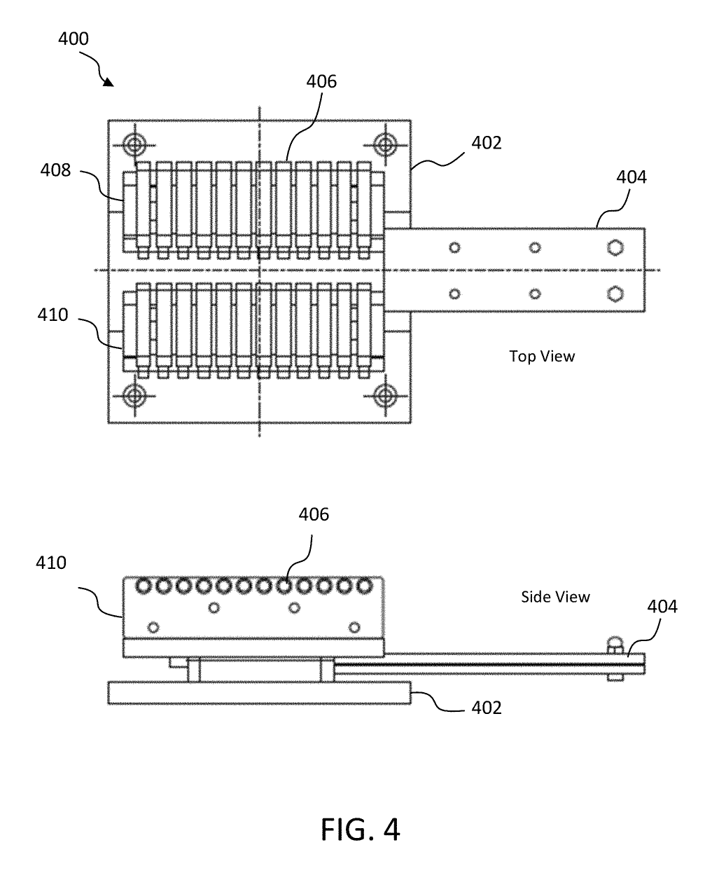

FIG. 4 shows a labware holding device 400 according to one embodiment of the disclosure. The labware holding device 400 can hold a plurality of labware containers 406 for marking at the same time. This increases the throughput of the marking process.

The labware holding device 400 includes a mounting arm 404. The mounting arm 404 fixes the labware holding device 400 in place. The labware holding device 400 includes a platform or base plate 402. The base plate 402 includes two labware holders 408, 410. In another embodiment, the base plate 402 may include four or eight labware holders.

As shown in FIG. 4, the each of the labware holders 408, 410 holds 12 labware containers in one row. In another embodiment, the labware holder 408, 410 can hold 48 or 96 labware containers.

In one embodiment, the marking system that includes the labware holder 400 may include a plurality of laser sources and optical scanners such that a plurality of labwares can be marked simultaneously.

In another embodiment of the invention, the information marking system can include a labware hotel, to increase capacity without heavily increasing its footprint. In this embodiment a labware hotel from which labwares can be loaded into the marking system is added to the information marking system.

In this embodiment of the invention, there can be an additional Z-axis. In this embodiment, not only the labware is making movements but the laser head can move in a vertical direction along an additional Z-axis that can position the marker to the correct shelf height of the labware hotel. Only the embodiment of the marking system that includes the labware hotel has the option of an additional Z-axis.

This embodiment of the marking system may include the following characteristics. The marking process is fully automated. The marking process operates at high speed, e.g., 15 secs/labware container. The marking process has a high walkaway capacity, e.g., of over 2.5 hours. The marking system has a marking area detection system for exact positioning of the labwares. The marking system has an optical reading system, such as e.g., a 2D code and 1D barcode scanner built-in to read pre-applied information on the labware containers. The marking system has a label verification system. The laser marks directly on the surface of labware containers from 0.75 ml to 15 ml. The marking system has spreadsheet file input\output capability.

In this embodiment, a manipulator can be used to open and close the drawers of the labware hotel's racking system. The manipulator can also move the drawers of the labware hotel for processing the labwares. The manipulator can pull out one shelf at a time and can take one labware at a time to the marking position.

A process of controlling the marking system may include the following steps. (1) The racks with labware containers are placed by the operator in a buffer called the labware hotel. Labware containers already have a 2D data matrix code on the bottom side. (2) The XYZ robotic system pulls one shelf out at a time and takes one labware container at a time to the marking position. The marking position has a rotary holder for bringing the marking surface in front of the laser. (3) The distance between the marking position and the laser (focus) is manually adjustable by moving the rotary holder. (4) The labware container fits in the rotary holder via the labware container “twist-locks”. The gripper stays in position to support the labware container at the top. (5) At the marking position a light sensor checks the position of the labware container. If the sensor looks through the labware container and the marking surface is facing the laser, the labware container is left in position. If the light sensor does not look through the labware container, the labware container must be turned 90 degrees to face the laser. (6) Once the orientation of the product is set the PLC communicates the code to the marking system software and starts the marking process. (7) When marking is done, the labware container is gripped again and placed back in its original position.

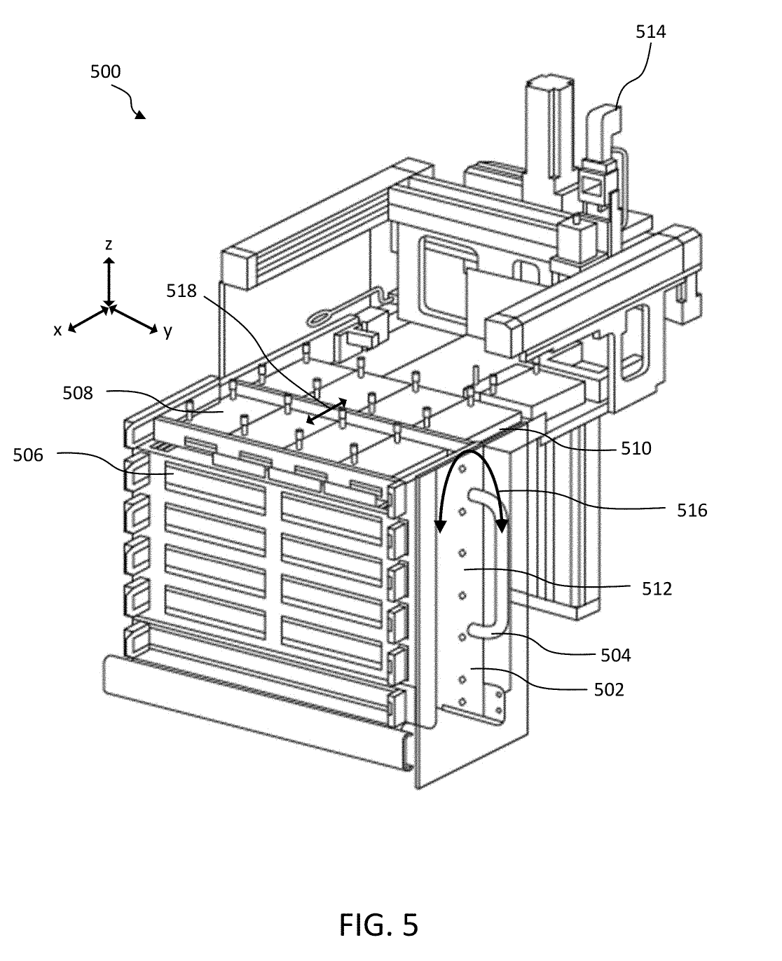

FIG. 5 shows a marking system 500 according to an embodiment of the disclosure. This embodiment has increased capacity by including a labware hotel. The marking system 500 has the capability of marking labware containers in a high-speed high-throughput manner. As shown in FIG. 5, the marking system 500 includes a rack system 512. The rack system 512 includes a front rack 506 and a back rack 502. Either of the front rack 506 or the back rack 502 includes at least six floors, wherein each floor stores at least 4 racks. Such floor rotation movement is part of an automatic feeding process for labware marking. The rack system 512 includes two handles 804, one on each side of the rack system 512. The handles 504 allow the rack system to be transported by manipulators.

The rack system 512 includes a first transportation mechanism that rotates the floors in clockwise or counter clockwise directions 516. In one embodiment, the first transportation mechanism rotates the floors such that a top floor 508 of the front portion is moved to a top floor 510 of the back portion, or vice versa, making a lateral movement in an X-axis direction. The top floor 510 of the back portion is a labware marking position, whereas the XYZ robotic system 514 can pick up the labware containers for marking. Such floor rotation movement is part of an automatic feeding process for labware marking.

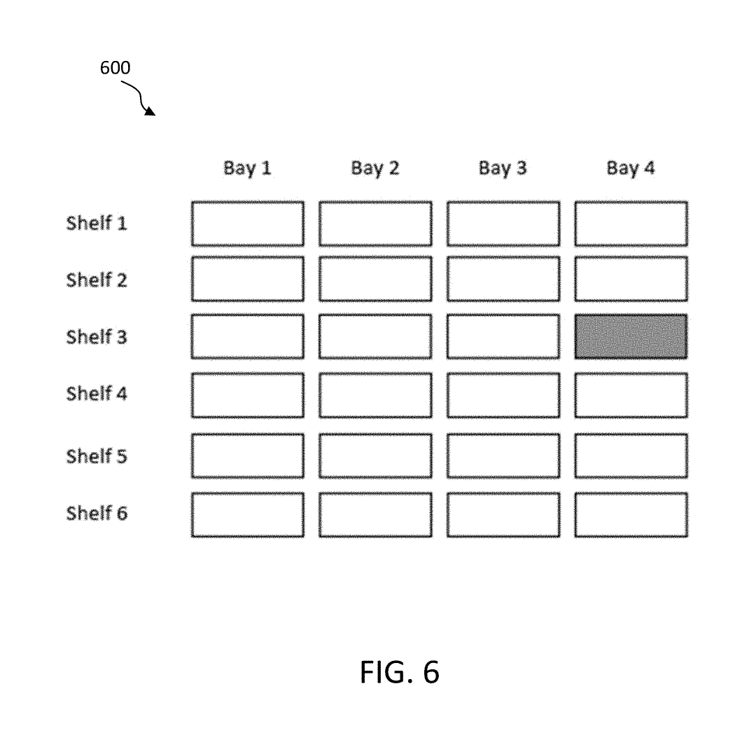

FIG. 6 shows an example of a labware hotel 600 drawer system that has 6×4 slots for receiving racks according to this embodiment.

The marking system may further include a labware holding device 300, 400 as shown in FIG. 3 and FIG. 4. For example, the XYZ robotic system 514 is configured to transport the labware containers from the racks to the labware holding device. The labware holding device 300, 400 holds the labware containers in a marking position for the laser to burn, print, or engrave the information on the labware containers.

Controlling and Detection

The information marker is controlled by software. The information that needs to be applied in the marking operation is entered into the software program of the information marking system. When the program is running, the marker marks the labware. When the marking operation is finished, the software notifies the user that the operation has ended.

In all embodiments of the marking system a computer, a processor, or the like, can be an integral part of the system or can be connected to the system from outside. In one form, the software can be installed on a computer, a processor, a mini-computer, or the like, that is integrated into the information marker. In another form, the information marker can be controlled by an external computer, processor, mini-computer, or the like, that is not integrated into the information marker. In that case, the information marker must be connected to the external computer, or the like, via one or more cables.

Other equipment can be integrated via software to work with the information marking system. The software of the marking system can get input from software connecting other laboratory equipment to the marking system. The software generated by such other connected applications can automatically provide information that needs to be marked on the labware. E.g., the information marker can utilize CSV input\output files or a different form of input\output files, enabling simple file-based integration with Laboratory Information Management Systems (LIMS). Thus, the marking process marks the information on the labwares in a fully automated way, minimizing the risk of human error.

Another option in the software is that information that needs to be marked on the labware is entered into the marking system automatically by the automatic reading of the pre-applied information on the labware. The pre-applied information on the labwares can be used by the software of the marking system as a data source (input). The software of the marking system links to the pre-applied information on the labwares (which can be in the form of machine readable codes, dot codes, 1D barcodes, 2D codes, QR codes, RF codes, or the like). The software uses this information as the input for the marking process by converting it to the laser-marked output on the marking surface. Thus, the marking process marks the information on the labwares in a fully automated way, minimizing the risk of human error.

For this option, a scanning device can be an integral part of the system or can be connected to the system from outside. The scanning device can be e.g., a camera, a reader, a scanner, or the like. The scanning device can be used to read pre-applied information on the labwares that need to be marked. The scanning device can also be used for positioning the labware in the correct position when labwares are used that are specially optimized for marking. In one form, the scanning device can be internal, i.e. integrated into the information marker. In another form, the scanning device can be external, i.e. not integrated into the information marker. In that case, the information marker must be connected to the scanning device via one or more cables.

In one embodiment, the data that are used by the information marker and the data that are generated by the marker system can be stored locally. In another embodiment, the data used by the information marker and the data generated by the information marker is sent to and stored on an external server or in the cloud.

In this section, as an example, an embodiment of marking system control software is described. The marking system includes a control software. The software provides: electrical drawings of the laser, electrical drawings of the CNC controlled Z-axis, model numbers, dimensions and weight, maintenance manuals in English, network and software support, and power consumption monitoring: voltage, phase, current consumption.

In one embodiment, the software can be written in C# using Microsoft Visual Studio 2017, or any other languages alike. The system comprises of a main XYZ gantry to pick-and-place labware containers from a series of racks. These labware containers are read with a 2D code reader (code on base of labware container), scanned with a camera to locate the marking area and finally engraved with a laser. The system is operated by an independent computer running the software.

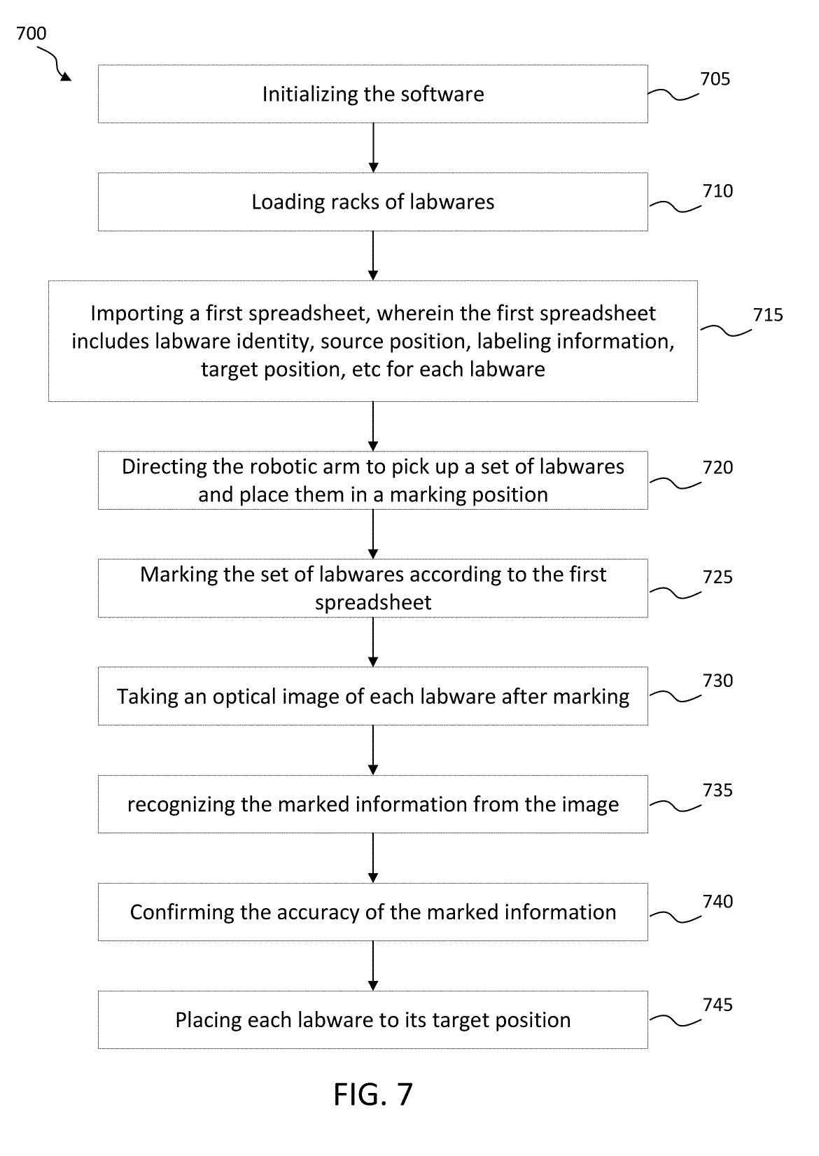

FIG. 7 shows a method 700 for marking labware containers according to one embodiment of the disclosure. The method 700 includes step 705, initializing the software. This step may include initializing the XYZ robotic system, the lasers, as well as the software settings.

The method 700 includes step 710, loading racks of labware containers. This step can be done manually by an operator. This step can also be done with automatic feeding process as previously disclosed in FIG. 5.

The method 700 includes step 715, importing a first spreadsheet. The spreadsheet includes various information regarding a labware container, e.g., a labware container identity, a source position, a labelling information (i.e., marking information), target position, etc. The source position means the labware container's original position before marking. The target position means the labware container's destination position after marking. In one embodiment, the source position is the same as the target position. In another embodiment, the source position is different from the target position.

The method 700 includes step 720, directing the XYZ robotic system to pick up a set of labware containers and place them in a marking position. In one embodiment, the set includes 1 to 32 labware containers.

The method 700 includes step 725, marking the set of labware containers according to the first spreadsheet. In one embodiment, the marking is done with laser.

The method 700 includes step 730, taking an optical image of each labware container after marking. This step can be done by using a camera.

The method 700 includes step 735, recognizing the marked information from the image. In one embodiment, this is done with optical character recognition (OCR).

The method 700 includes step 740, confirming the accuracy of the marked information. This is done by comparing the recognized information with the intended information provided by the first spreadsheet. If the marked information is correct, proceed to 745. If the marked information is not correct, record the labware container identity to an error log.

The method 700 includes step 745, placing each labware container to its target position.

Software Application Overview. The software package can manage all device operations via an USB connection. The software runs on a provided computer running adjacent to the labware container marker. The software manages all aspects of the process, from the labware container rack setup to the robot operations.

The user need only interact with the computer software for configuration and normal operation (outside of loading and unloading). An emergency stop (E-Stop) exists on the device however this should be not operated under normal circumstances.

Network Infrastructure and IP Addresses. The network infrastructure for the device is relatively simple. The laser module connects via USB interface with the main control board connecting via ethernet.

The following network IPs are assigned. All these devices use a subnet mask of 255.255.0.0. An address 10.0.0.1 can be assigned to a host machine. An address 10.0.0.10 can be assigned to a main process board. Another address 10.0.0.11 can be assigned to barcode reader.

Marking Workflow Overview. Marking operations follow a relatively simple procedure. Once all rack positions are specified in software with their respective data fields the marking process can begin.

Racks and labware containers. Labware container details are to be stored in the main application database. These can then be exported/imported.

Database Design. The system uses a MySQL database to store state information, system parameters and labware container details. The database is accessible by the system software and requires a username/password to log in and access the information.

Log Files. Log files are created during operation. These files contain a full list of all the actions that have been performed and any warning or error messages. The log files are used for the sole purpose of tracking down system issues and errors and are not expected to be viewed on a regular basis for process information or output data. The files are stored in an HTML format that highlights several types of messages so they are easy to read (e.g. errors appear highlighted in red).

A metrics table in the database stores lifetime device statistics, including total travel and laser time. These can be interfaced in a multitude of ways including a call home. The implementation of the statistic retrieval depends on the customer and device version.

Graphical user interface. Design & Layout. The base application handles all high-level robot operations. It also handles the user interface. It features many of the common functions including hardware configuration, Merlin library integration and process methods.

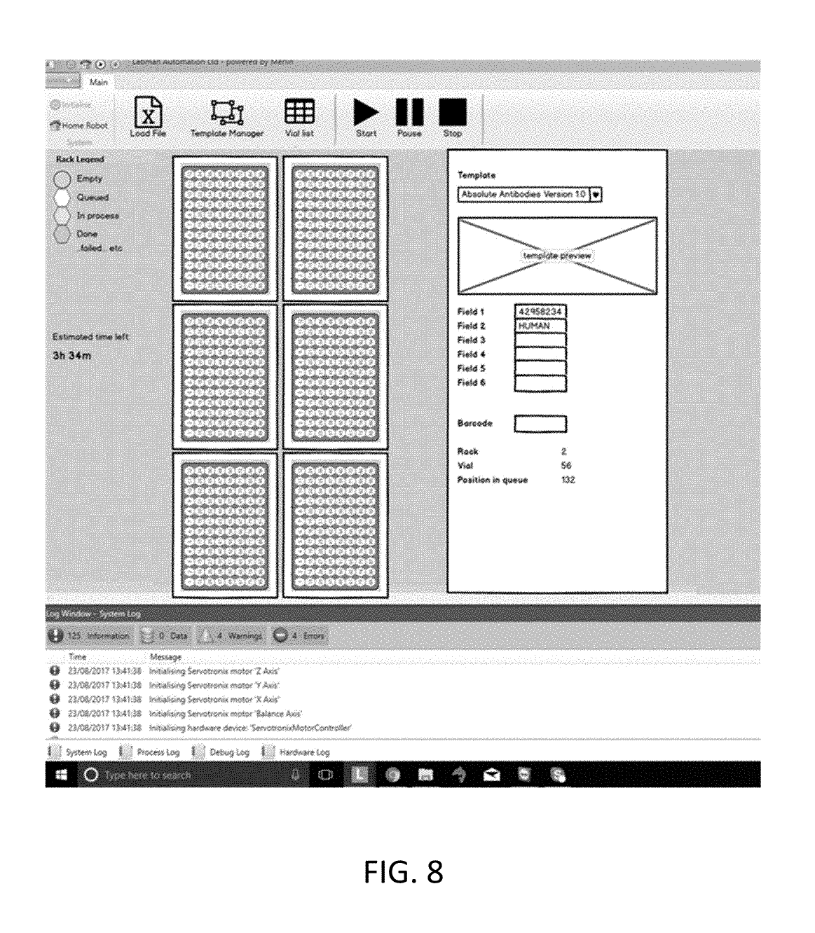

User Interface. FIG. 8 shows a graphical user interface (GUI) of a main screen from which most operations will be performed according to one embodiment of the disclosure. As shown in FIG. 8, on the left is a visual representation of the state of the machine; on the right are the details for the currently selected labware container. The current labware container under edit is selected by clicking on it in the visualization.

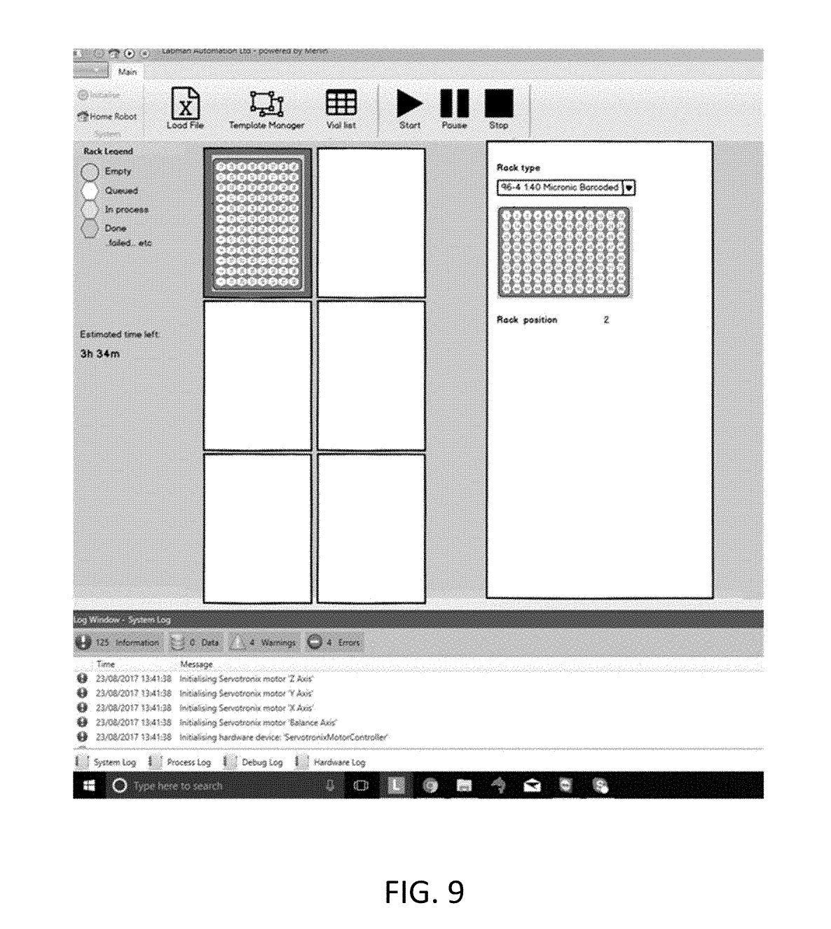

Rack edit. FIG. 9 shows a GUI of a rack edit according to one embodiment of the disclosure. This is like the screen above, however the distinction is made by clicking on a rack instead of a labware container. This allows the user to select and load racks.

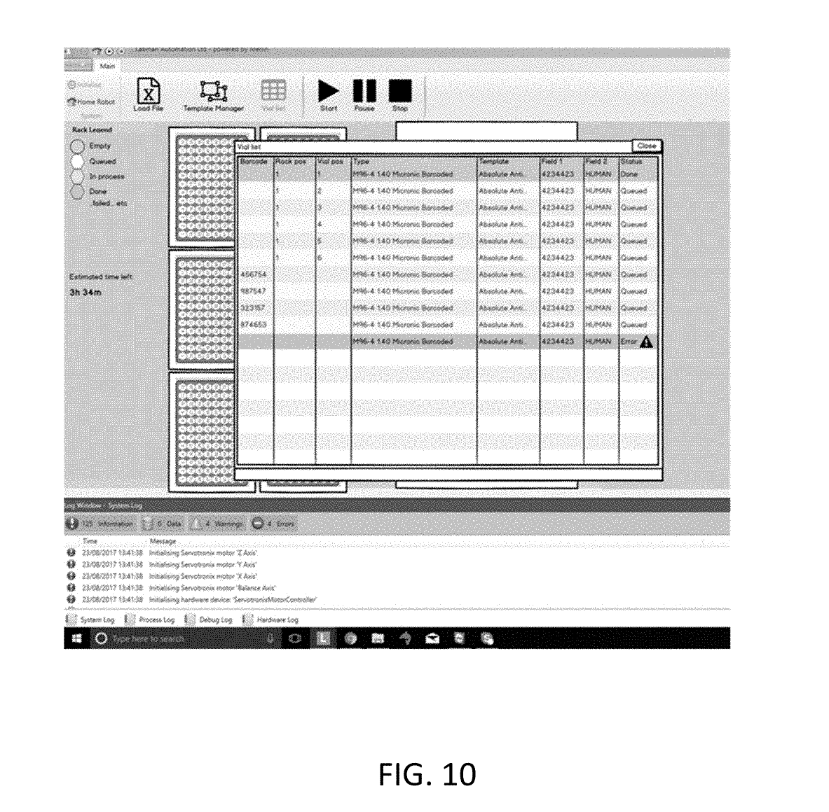

Labware container list. FIG. 10 shows a GUI allowing a user to view and edit the global labware container list according to one embodiment of the disclosure. Either a barcode OR position is needed for each labware container.

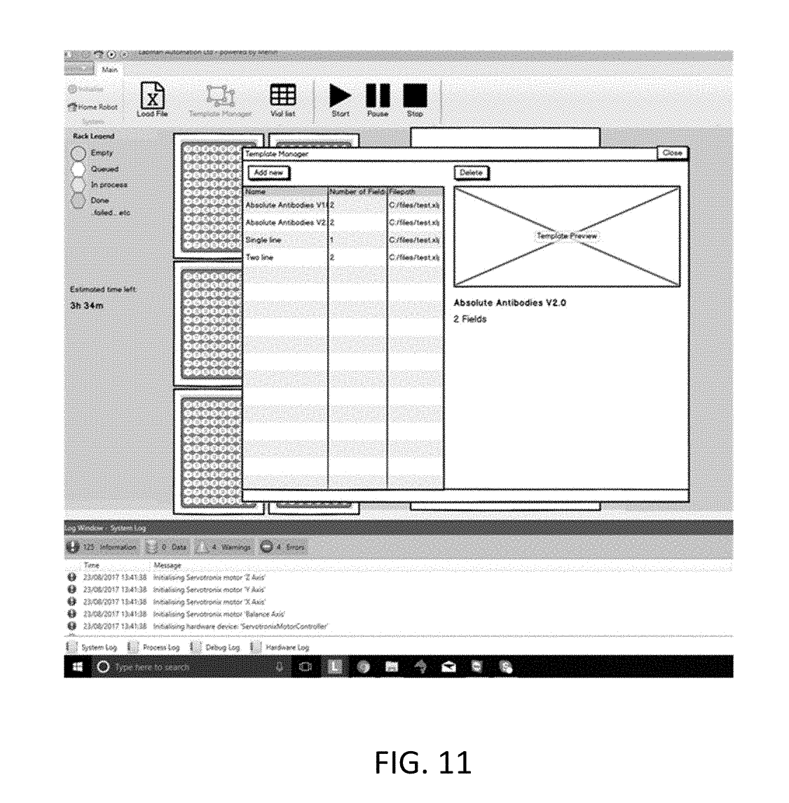

Template manager. FIG. 11 shows a GUI allowing a user to manage the laser template files according to one embodiment of the disclosure. A pre-rendered preview of each template is shown to aid the user.

Marking Information

The information marking system and its various embodiments herein provided can mark information on the labwares that can be read by humans (e.g., text marking). The information marking system can also mark information on the labwares that can be decoded by hardware including software (e.g., code markings). In one form, the markings can be texts, images, machine readable codes, dot codes, 1D barcodes, 2D codes, QR codes, or the like. In another form, marking can be done via the incorporation into the labware of a chip (e.g., an RFID chip).

In all embodiments, the marking system marks the information on the labwares in such a manner that the markings are indelibly and permanently attached to the labwares. The markings are resistant to high and low temperatures, ranging from −196° C. to >100° C. The markings are resistant to liquids such as e.g., water, alcohol, solvents, liquid nitrogen, or the like. The markings are resistant to heavy wear and tear that may result from handling such as e.g., mechanical abrasion, or the like. Such durable markings can be accomplished by laser etching, engraving, printing (e.g., using ink, thermal printing, ink-jet printing, or other printing methods), or the like.

In some embodiments, the labwares contain pre-applied information, e.g., a 1D barcode or a 2D code on the bottom, top or side of the labwares. In other embodiments, the labwares contain a pre-applied information carrier such as an RFID chip, or the like. When this is the case, the pre-applied information can be read by the information marking system with sensors, such as cameras, optical sensors, RF sensors, or the like. In all embodiments, the pre-applied information can be used by the software of the marking system as a data source (input).

In some embodiments, the information marking system enables labware customization by marking additional information that needs to be applied to the labware.

One such customization can be the incorporation of a label verification system, e.g. by capturing and storing the image of the information applied to the labware, for later verification. Another such customization can be the possibility to record the volume of the substance in the container. Yet another such customization can be the possibility to record information on e.g., manufacturing date of the substance in the container, date of handling of the labware, personalized information relating to the substance in the container, or the like. Yet another such customization can be the possibility to sort the labwares after marking (e.g. for laser etching, printing, engraving with other means).

Specially Designed Labwares

In one form of the invention, labware products used in the marking system may be designed in such a way that they are specially suitable for marking with information on a marking surface.

The following is a description of a specially designed labware. Specially designed labware is labware that is optimized for additional coding or codings. In general, labwares can be transparent. Labwares can also be translucent, opaque, colorized or solid. Colours can range e.g., to white, grey or black. Such surfaces of labwares are generally difficult to mark due to a limited contrast with the background. Specially designed labware has additional coding areas on the labware. These additional coding areas are optimized for laser etching as they provide an optimized contrast of the marking compared to the marking surface. The surface of the identification area can be optimized, e.g. for specific coding techniques that improve the connection between the surface and the ink or to enable better reading of the code by preventing reflection.

The following shows various exemplary embodiments of specially designed labwares.

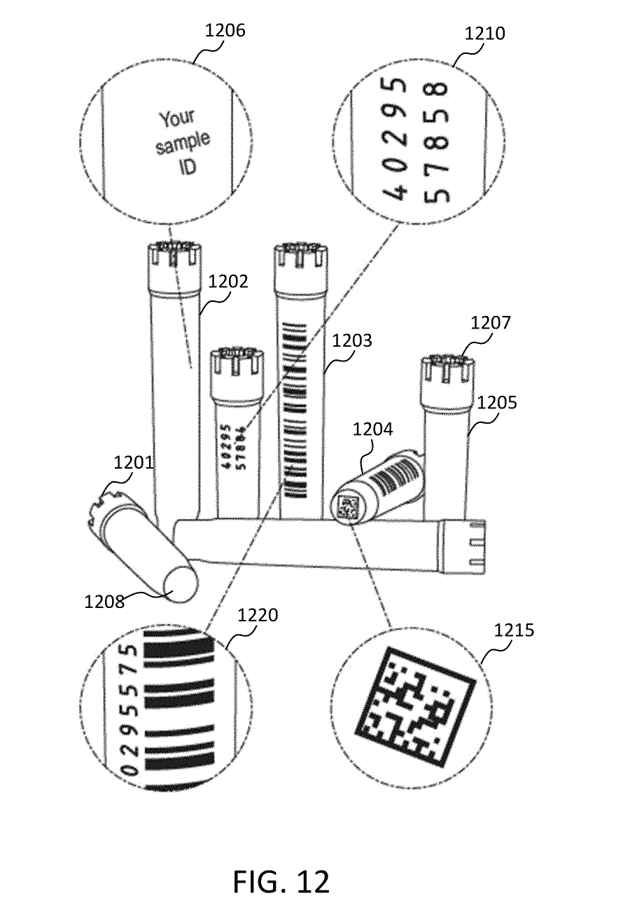

FIG. 12 shows various embodiments of labware containers 1201, 1202, 1203, 1204, 1205 with markings according to an embodiment of the disclosure. The labware containers 1201, 1202, 1203, 1204, 1205 include a tubular body and include an internal cavity that stores the samples inside.

The external surface of the tubular body may include various markings. In one example, the marking may be text 1206. The text 1206 can be in any given language, e.g., English, French, Dutch, Chinese, Japanese, etc. In another example, the marking can include numbers 1210. In yet another example, the marking can include barcode 1220. All the markings 1206, 1210, 1220 can be automatically recognized by a machine equipped with at least an optical sensor. It is possible that the tubular body may include an RFID chip, such that the identity of the labware can be wirelessly sensed.

The labware containers 1201, 1202, 1203, 1204, 1205 have a cap 1207. The cap 1207 may be threaded to such that when twisted onto the tubular body an air tight seal is formed. In another embodiment, the cap 1207 may form an air tight seal with the tubular body with a snap-on mechanism.

The labware containers 1201, 1202, 1203, 1204, 1205 include a flat bottom 1208. The flat bottom allows the labware containers 1201, 1202, 1203, 1204, 1205 to stand in an up-right position as shown in FIG. 12 (e.g., 1202, 1203, 1205) by itself.

The flat bottom 108 may include identification information 1215, e.g., text, symbol, figure, 1D barcode, 2D code. The identification information 1215 can be automatically recognized by a machine equipped with at least an optical sensor. It is possible that the flat bottom 108 may include an RFID chip, such that the identity of the labware can be wirelessly sensed.

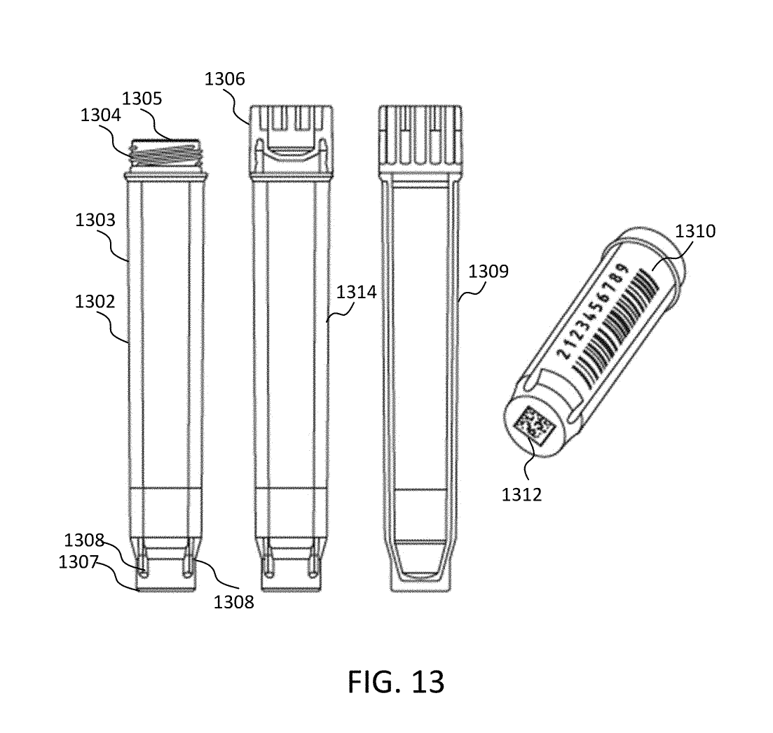

FIG. 13 shows various embodiments of labware containers 1302, 1309, 1314 with markings according to an embodiment of the disclosure. The labware container 1302 includes a top portion 1305, a body portion 1302, and a bottom portion 1307.

The top portion 1305 has threads 1304 that matches against threads disposed within a cap 1306 forming an air tight seal. The body portion 1302 includes an internal cavity that stores the sample inside. The external surface of the body portion 1302 can be marked with desired markings 1310.

The bottom portion 1307 may include protrusions 1308. The protrusions may be symmetrically or asymmetrically distributed around the circumferences of the bottom portion 1307. In one embodiment, two, three, four, five, or six protrusions symmetrically or asymmetrically distributed around the circumference of the bottom portion 1307. The protrusions allow the labware container 1302 to be inserted in a specific orientation or direction on a rack, which holds a plurality of labware containers. Organizing the labware container 1302 in a specific orientation on a holder is beneficial because the markings 1310, 1312 may be positioned in an orientation such that it is easy to scan or read. In another embodiment, the labware container 1309 may not include any bottom portion protrusion.

The bottom portion 1307 further includes markings 1312. In one embodiment, a rack may collect a matrix of labware containers, wherein the markings 1312 located at the bottom of the labware containers can be read by an optical sensor(s).

In one embodiment, the labware 1302, 1309, 1314 includes two separate structures: a container structure and a labelling structure. The container structure forms a cavity for receiving samples. The container structure is made with a material (e.g., polyethylene, glass, etc.) that is chemically inert with an intended sample. The labelling structure is annealed onto the container structure. Because the labelling structure does not contact the sample, the labelling structure may be made with a material that is suitable for marking (laser, ink printing, thermal printing, etc.), but not necessarily being chemically inert to the sample. The labelling structure can be made with specific materials or be in specific colors to enhance the readability of the pre-applied and/or customarily marked information. The labelling structure may include two portions, a first portion (e.g., 1312) contains pre-applied information that uniquely identifies the specific labware. The second portion (1310) of the labelling structure may be marked with customized information. The first portion (e.g., 1312) of the labelling structure may wrap around a bottom portion of the container forming the bottom portion protrusion. The second portion (e.g., 1310) of the labelling structure may wrap around, at least partially, a side wall of the labware.

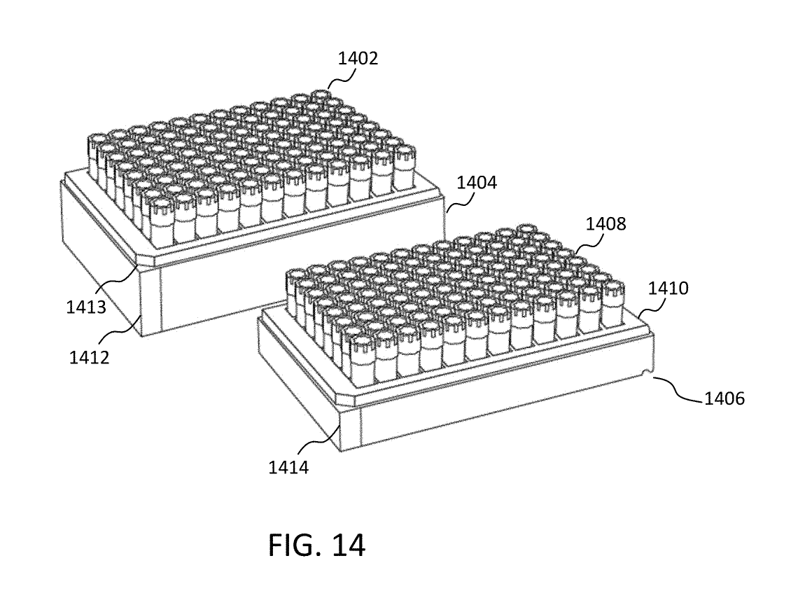

FIG. 14 shows a plurality of labware containers 1402, 1408 organized on a rack 1404, 1410 according to an embodiment of the disclosure. As shown in FIG. 14, the rack 1404, 1410 collects a matrix of 12×8 (=96) labware containers 1402, 1408. The rack 1404, 1410 includes a notch 1406. The notch 1406 allows the rack to be secured correctly in a rack placing slot of a marking system. The rack 1404 and 1410 may have different heights 1412, 1414. As shown in FIG. 14, the height of 1412 is larger than 1414. In one embodiment, a larger height, e.g., 1412, allows multiple racks to be stacked on top of each other.

Dimensions of a specially designed labware container can include: 1. Height of the labware container is normally between 16 mm (0.63″) and 102 mm (4″) but not limited to. 2. The diameter is normally between 7 mm (0.28″) and 17 mm (0.67″) but not limited to. 3. Volume of these labware containers is normally between 0.25 ml and 14 ml but can be of any volume.

Labware containers are normally stored in a rack according to ANSI format like 96-format (8×12), 48-format (6×8), 24-format (4×6) but not limited. Other common formats are 384-format (16×24), 12-format (3×4) and 6-format (2×3). Labware containers can also be stored in cryo boxes in square, such as 9×9, 10×10, 12×12, 14×14 and others.

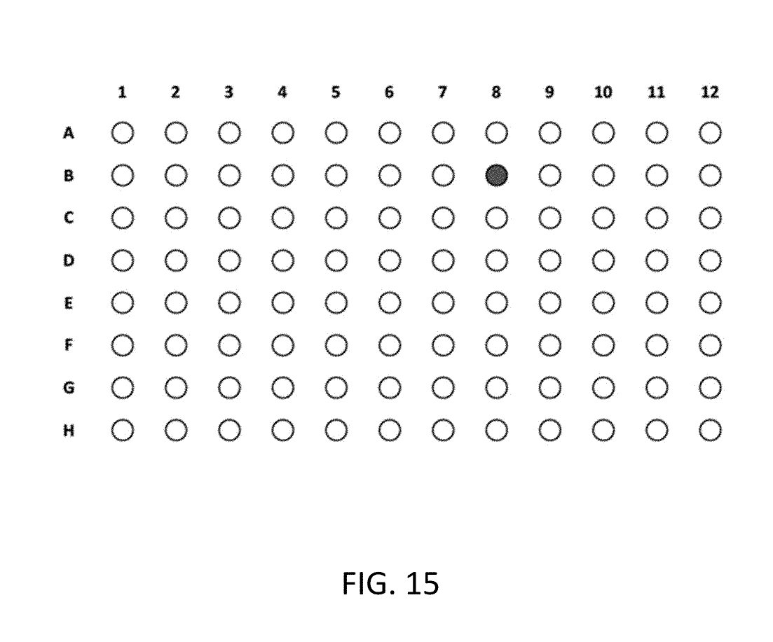

FIG. 15 shows an example of 96-format of labware containers, with 8 rows (A-H) and 12 columns (1-12). The position of each labware container in the rack is described by the row and column coordinate (e.g., B8).

Labware containers can be closed with push caps, screw caps (internally or externally threaded), heating foil and others. The labware containers can have one or more additional features such as an anti-rotation feature, a snap feature for a rack, a grip feature for automatic handling, anti-scratching surface and others.

Material is normally polypropylene but can also be polystyrene or other. Material should be chemical resistant. The main part of the labware container is normally transparent but can be translucent, opaque, colorized or solid. The top of the labware container can have features for easy gripping manually, with tools or automated. Another or same material can be embedded in the labware container for identification purposes. This material is fixated to the main part. In some situations it can be desirable if the main part is used directly for the identification and no second part is added.

Identifications can be a human readable code (such as numbers or written text); a 1D code (e.g., a barcode); a 2D-code (e.g., a 2D Data-matrix or a QR-code); some kind of a mechanical identification such as an RFID chip or a MEMS chip, a micro transponder, or the like. Identifications can be one code only or can be a combination of codes.

Identification can be pre-molded, printed, engraved, (laser-)etched or by other techniques. Identifications such as text and codes are normally contrasting with the background.

The labware container can have a code area on the bottom for reading the identification from the bottom when the labware containers are placed side to side in a rack. A cluster of labware containers can be read simultaneously or in batch. For printing or for reading the identification from the side of the labware containers, the labware containers should be lifted from the racks. On the side of the labware container there can be one, two or more solid surfaces where an identification can be applied. The second part can be attached to the bottom part but can also be a separate part on the side of the labware container. Another version of the labware container can be that the labware container solely has side areas and no bottom area.

The code content on the bottom is normally equal to (one of) the code(s) on the side. Normally the labware containers have a pre-applied identification on the bottom and/or on the side but other identifications are possible, too.

What is claimed is:

1. An automated labware marking system, comprising
a platform, the platform including at least one slot for receiving a labware, the labware including a rack and a plurality of labware containers, the rack further including a plurality of cavities for receiving the plurality of labware containers;
a marking device for marking the labware;
a first sensor that detects a marking area on the labware for marking;
a second sensor that is configured to take information of each labware container before the labware container is marked by the marking device; and
a manipulator, wherein the manipulator moves at least one labware container from the rack to a labware holding device and places the at least one labware container in a position suitable for marking by the marking device.

2. The automated labware marking system according to claim 1, further including
a controller, wherein the controller is configured to receive an electronic file containing instructions, the controller controls the manipulator to pick up a labware according to the instructions, the controller controls the marking device to mark the labware according to the electronic file.

3. The automated labware marking system according to claim 1, wherein the rack includes a matrix of 16×24, 14×14, 12×12, 10×10, 8×12, 9×9, 6×8, 4×6, 3×4, or 2×3 cavities for receiving labware containers.

4. The automated labware marking system according to claim 1, wherein the manipulator has two or three dimensional moving capability.

5. The automated labware marking system according to claim 1, wherein the manipulator has rotational moving capability.

6. The automated labware marking system according to claim 1, wherein the marking device is a laser, a red light laser, an engraver, a printer, a thermal printing system, a thermal strip labeler, or a device that incorporates a chip.

7. The automated labware marking system according to claim 1, wherein the first sensor detects a location of a border of the marking area, the manipulator places the labware in the position suitable for marking based on the location of the border of the marking area.

8. An automated labware marking system, comprising
a platform, the platform including at least one slot for receiving a labware, the labware including a rack and a plurality of labware containers, the rack further including a plurality of cavities for receiving the plurality of labware containers;
a marking device for marking the labware;
a first sensor that detects a marking area on the labware for marking;
a second sensor that is configured to take information of each labware container before the labware container is marked by the marking device, the second sensor is configured to take further information of each labware container after the labware container is marked by the marking device; and
a manipulator, wherein the manipulator moves at least one labware container from the rack to a labware holding device and places the at least one labware container in a position suitable for marking by the marking device.

9. The automated labware marking system according to claim 8, further including
a controller, wherein the controller is configured to receive an electronic file containing instructions, the controller controls the manipulator to pick up a labware according to the instructions, the controller controls the marking device to mark the labware according to the electronic file.

10. The automated labware marking system according to claim 8, wherein the rack includes a matrix of 16×24, 14×14, 12×12, 10×10, 8×12, 9×9, 6×8, 4×6, 3×4, or 2×3 cavities for receiving labware containers.

11. The automated labware marking system according to claim 8, wherein the manipulator has two or three dimensional moving capability.

12. The automated labware marking system according to claim 8, wherein the manipulator has rotational moving capability.

13. The automated labware marking system according to claim 8, wherein the marking device is a laser, a red light laser, an engraver, a printer, a thermal printing system, a thermal strip labeler, or a device that incorporates a chip.

14. The automated labware marking system according to claim 8, wherein the first sensor detects a location of a border of the marking area, the manipulator places the labware in the position suitable for marking based on the location of the border of the marking area.

15. A labware, comprising a container, the container including an internal cavity for receiving samples; and
a label structure, the label structure being attached to an external surface of the container, the label structure further including
a first portion, the first portion including pre-applied information, the pre-applied information uniquely identifies the labware; and
a second portion, the second portion being configured to be marked with a customized information.

16. The labware according to claim 15, wherein
the label structure is made with a material different from the container,
the label structure wraps around a bottom portion of the container; and
the label structure wraps around, a least partially, a side wall of the container.

17. The labware according to claim 15, wherein
the second portion is capable of being marked by a marking device, the marking device is a laser, a red light laser, an engraver, a printer, a thermal printing system, a thermal strip labeler, or a device that incorporates a chip.

18. The labware according to claim 15, wherein the label structure is made with a material or in a color that enhances a readability of the pre-applied information and/or a marked information of the second portion.

19. The labware according to claim 15, wherein the pre-applied information has the capability to be read by a human or a machine.

20. The labware according to claim 15, wherein the customized information has the capability to be read by a human or a machine.
